(19) United States
(12) Patent Application Publication
(10) Pub. No.: US 2008/0025495 A1
(43) Pub. Date: Jan. 31, 2008

(54) Method and System for Securing Scrambled Data

(75) Inventors: Gilles Merle, Verneuil Sur Seine (FR); Francois Bangui, Paris (FR)

Correspondence Address: OBLON, SPIVAK, MCCLELLAND MAIER & NEUSTADT, P.C., 1940 DUKE STREET, ALEXANDRIA, VA, 22314, US

(73) Assignee: VIACCESS, PARIS LA DEFENSE CEDEX (FR)

(21) Appl. No.: 10/541,510

(22) PCT Filed: Dec. 22, 2003
(86) PCT No.: PCT/FR03/50202

§ 371 Date: Jul. 18, 2007

(30) Foreign Application Priority Data
Dec. 24, 2002 (FR) 02 16650

(51) Int. Cl. H04K 1/00

(52) U.S. Cl. 380/28

(57) ABSTRACT

A distribution process with access control of scrambled data to at least one receiver terminal. The process includes an encryption phase that subdivides the data into an integer of families each including an integer of blocks, assigns each family a specific identification parameter associated with at least one descrambling module having a specific processing capacity and a level of security, and scrambles each block of a family of a type by a key in biunivocal relation with the parameter. A descrambling phase identifies the family of each block and descrambles each block of a family of the type by the descrambling module by the key.

### TECHNICAL FIELD

The invention relates to the field of access control to scrambled data.

It concerns more specifically a process for securing scrambled data supplied to a plurality of terminals, each of said terminals comprising a plurality of descrambling modules Mj (j=1 . . . M) , each having a specific processing capacity and a specific level of security, said data being previously subdivided into M families Fj (j=1 . . . M), each comprising N blocks Bi (1=1 . . . N), each block Bi (i=1 . . . N) of a family Fj being scrambled by a key Kj (j=1 . . . M) associated with the family Fj.

The receiver terminals are mobile equipment (ME) (Mobile Equipment) for widespread public use such as for example portable telephones, personal digital assistants known PDA or even audiovisual receiver or computers.

The invention also relates to a system for securing data and/or services comprising a scrambling platform and an descrambling platform for implementing the process.

The data to be secured are literary or artistic works protected by a digital rights management system DRM (Digital Right Management). These works can either be stored on media such as for example a CD ROM or a DVD, or transmitted or downloaded from a remote server to a plurality of receiver terminals connected to a transmission network.

### PRIOR ART

In systems for securing data of the prior art, the content to be protected (audio, video, text) is scrambled at the operator end and deciphered, as it is being received by the subscriber by an descrambling algorithm stored in the receiver terminal.

A major disadvantage of these systems originates from the fact that on reception, the entire distributed content is descrambled by the same descrambling module. Also, in the event of pirating, all this content becomes accessible and can then be redistributed fraudulently over illicit networks.

A first solution known to solve this problem consists of confining the descrambling module to premises with secure access. This solution is not adapted to those applications in which the terminals are for widespread public usage.

A second solution, based on the reinforcement of the security of the receiver itself, consists of preventing installation on the terminal of any suspect software and authorising the installation solely of “certified” software, that is, software for which downloading authorisation has been given.

This solution also is not adapted to the applications cited above which utilise “open” receivers fitted with an input/output interface enabling any type of software (computers, audio and video receivers) to be downloaded, by comparison to terminals “locked” by fabrication, such as decoders for example, to prevent a subscriber from fraudulently downloading descrambling software.

The aim of the invention is to overcome the abovementioned disadvantages of the prior art.

### DESCRIPTION OF THE INVENTION

The invention proposes a method for securing scrambled data supplied to a plurality of receiver terminals, in which each of said terminals comprises a plurality of descrambling modules Mj (j=1 . . . M), each having a specific processing capacity and a specific level of security, and in which the data are previously subdivided into M families Fj (j=1 . . . M), each comprising N blocks Bi (i=1. . . N), each block Bi (i=1 . . . N) of a family Fj then being scrambled by a key Kj (j=1 . . . M) associated with the family Fj.

According to the invention said blocks Bi (i=1 . . . N) are previously organised as a function of the respective processing speeds of the descrambling modules Mj.

According to the invention the modules Mj (j=1 . . . M) are different peripheral elements associated with said receiver terminal.

Owing to the invention an attack on one of the modules Mj (j=1 . . . M) allows an incomplete file to be reconstructed, as it lacks the part processed by the other modules. The pirated file will be severely degraded relative to the original and thus unexecutable.

In a first embodiment, the descrambling modules Mj (j=1 . . . M) comprise different algorithms Aj (j=1 . . . M).

In a second embodiment the descrambling modules Mj (j=1 . . . M) comprise identical algorithms Aj (j=1 . . . M).

In the two embodiments, the data to be distributed are in the form of a previously stored file or in the form of a stream broadcast in real time.

In a particular application of the process according to the present invention, the stream of data represents audio and/or video programs or animated drawings (multimedia animation), or even images of syntheses protected by a DRM system.

The invention also relates to a system for securing scrambled data comprising a scrambling platform and a descrambling platform.

The scrambling platform comprises:

means for subdividing said stream into M distinct families of N blocks Bi (i=1 . . . N),

means for assigning to each family a specific identification parameter pj (j=1. . . M) associated with at least one descrambling module Mj having a specific processing capacity and a specific level of security,

means for scrambling each block Bi by a key Kj (j=1 . . . M) in biunivocal relation with the parameter pj.

According to an essential characteristic of the invention, said descrambling platform comprises means for identifying the family of each block Bi so as to descramble each block Bi of a family of type pj by the module Mj corresponding to said parameter pj.

According to a preferred embodiment, the descrambling platform comprises a plurality of distinct descrambling modules Mj (i=1 . . . M).

In a another embodiment of the invention, the data to be secured are audiovisual programs broadcast to a plurality of subscribers equipped with a user licence managed by a DRM system.

The mobile equipment can be a PDA or a mobile telephone fitted with a SIM (Subscriber Identity Module) smart card.

In this case, the data are distributed between a first descrambling module M1 integrated in the PDA (respectively in the mobile telephone) and a second descrambling module M2 constituted by the smart card itself.

### BRIEF DESCRIPTION OF THE DRAWINGS

Other characteristics and advantages of the invention will emerge from the following description, given by way of non-limiting example in reference to the attached figures, in which:

FIG. 1 schematically illustrates a stage of typing data to be secured by the process according to the present invention,

FIG. 2 schematically illustrates a stage of scrambling a family of data obtained by the previous stage,

FIG. 3 schematically illustrates a first embodiment of the first and second stage of the process according to the present invention,

FIG. 4 schematically illustrates the descrambling phase for families of data obtained by the preceding stages,

FIG. 5 illustrates a preferred embodiment of the stage illustrated by FIG. 4,

FIG. 6 schematically illustrates a terminal employing the process according to the invention,

FIG. 7 illustrates a time chart schematically illustrating processing by the process according to the invention of a stream of data broadcast or downloaded in real time by the terminal,

FIG. 8 illustrates a time chart illustrating management of the scrambling keys of the stream of FIG. 7.

### DETAILED DESCRIPTION OF PARTICULAR EMBODIMENTS

The following description relates to an implementation of the invention in which the scrambled data represent audio and/or video programs broadcast or downloaded to a PDA (Personal Digital Assistant) comprising a SIM smart card. The PDA comprises a first descrambling module M1, a second descrambling module being the SIM card itself.

The data to be secured can be downloaded from storage media (CD, DVD) or from a specialised server (music, video, anime, ring tones, electronic ebook).

They can also be broadcast over a network.

Irrespective of the implementation in question and the type of data, before these data are distributed, the process comprises:

a first processing phase comprising:

a typing step consisting of forming M families Fj (j=1 M) of data each comprising a number nj of blocks of data Bi (i=1 . . . N), each family being identified by a parameter pj.

a scrambling step of each block Bi of a family Fj by a key Kj (j=1 . . . M) in biunivocal relation with the parameter pj.

and on reception of the data by a terminal the former undergo a second processing phase comprising:

an identification step of the family of each block Bi received,

a descrambling step of each block Bi by means of the key Kj by a module Mj (j=1 . . . M) identified by a parameter pj.

According to an essential characteristic of the invention, the modules Mj (j=1 . . . M) which help descramble the blocks Bi of two distinct families are different.

These can be either different peripheral devices associated with the receiver terminal, or independent software stored in the memory of the terminal or a peripheral device.

### Case of a Previously Stored Data File.

Typing

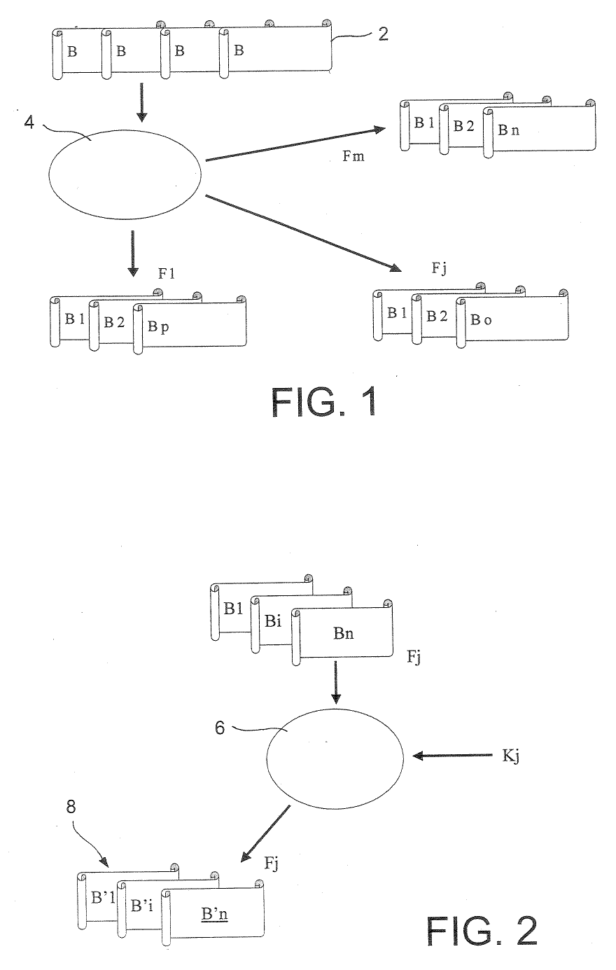

FIG. 1 illustrates an audio and/or video data file 2 organised in blocks known as access units AU (Access Unit) according to the MPEG 4 standard (Motion Picture Expert Group).

A first step 4 of the method consists of partitionning the file 2 into m families Fj (j=1 . . . m) each comprising an integer nj of blocks Bi (i=1 . . . N); each family Fj is identified by parameter pj (j=1 . . . m).

The parameter pj also identifies the module Mj which will be responsible for descrambling the blocks Bi of the family Fj.

In the described implementation, the file is portioned into two families F₁ and F₂ whereof the respective blocks will be descrambled respectively by a module M1 integrated in a PDA and by the SIM card constituting the module M2.

During typing, a parameter p1 is associated with the family F₁ of blocks Bi which will be descrambled by the module M1 and a parameter p2 is associated with the family F₂ of blocks Bᵢ which will be descrambled by the SIM card.

Scrambling

FIG. 2 illustrates a second step 6 during which the blocks Bi of a family Fⱼ are scrambled by a key Kj (j=1, 2) defined as a function of the respective processing capacity and the degree of security of the module M₁ integrated in the PDA and the SIM card. The scrambled blocks B′ᵢ are stored in a file 8.

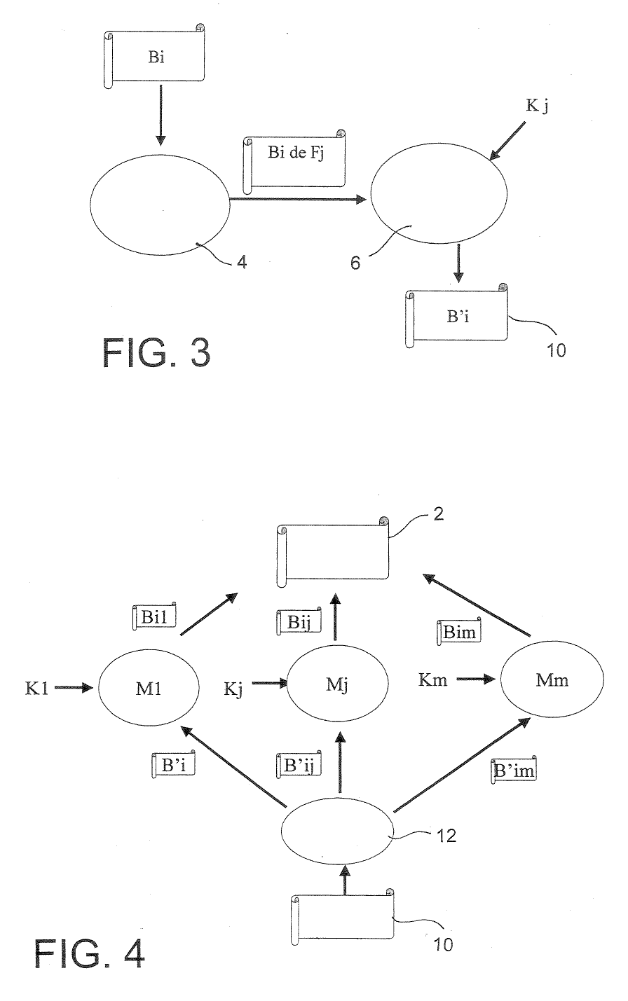

In a another embodiment of the method illustrated schematically by FIG. 3, the typing 4 and the scrambling 6 of a block Bᵢ are carried out successively.

In another embodiment, not shown, the scrambling is done family by family.

The file 10 containing the scrambled blocks B′ᵢ is then transmitted to the PDA.

Descrambling

FIG. 4 illustrates the descrambling phase of a file 10 comprising distinct families Fj of previously scrambled MPEG blocks.

At stage 12, the blocks B′ᵢ are identified by their respective parameter pⱼ, then routed to the corresponding descrambling modules Mⱼ.

The deciphered blocks are then rearranged to form the original file 2 which will be supplied to the user.

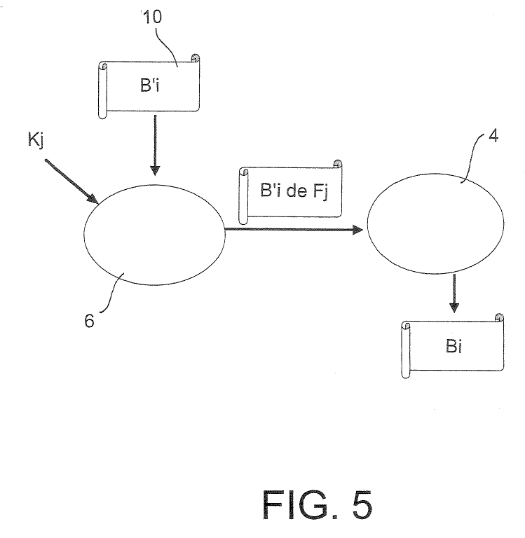

FIG. 5 schematically illustrates a preferred embodiment of the descrambling in which the blocks Bi contained in the file 10 are processed on the fly block by block.

Time Processing of a Stream of Data

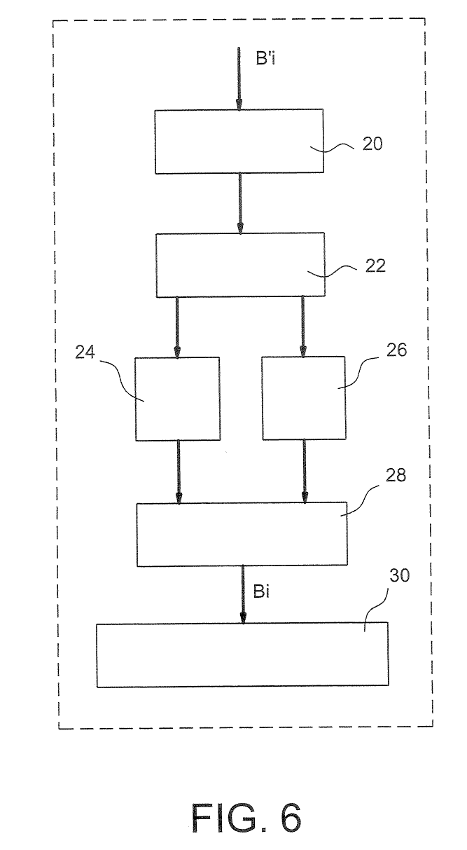

FIG. 6 schematically illustrates the internal modules of a PDA enabling descrambling.

The PDA illustrated comprises an input stage 20 for identifying the blocks B′i in a stream, a demultiplexing stage 22, a first descrambling module 24, a smart card constituting a second descrambling module 26, a multiplexing stage 28 and an output stage 30.

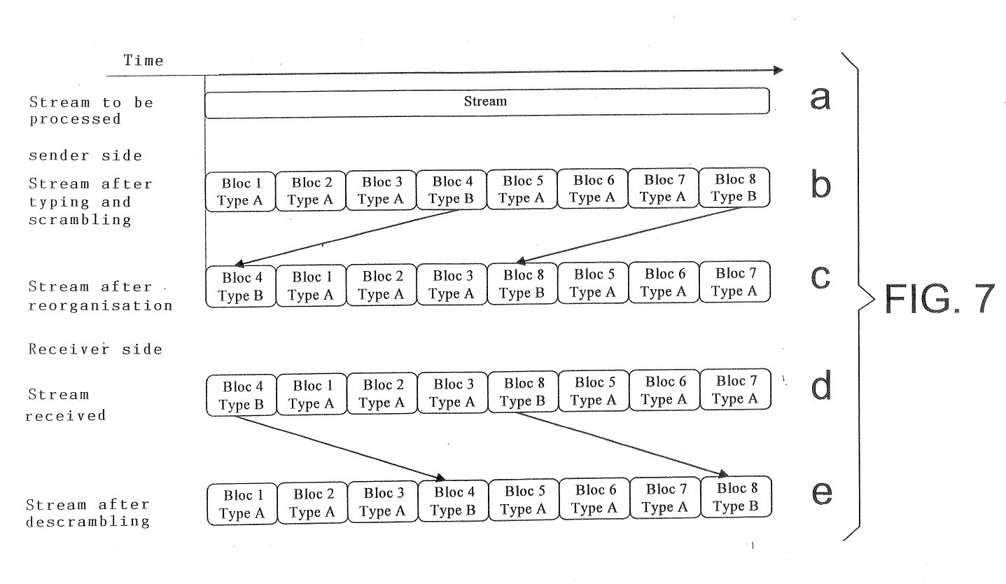

FIG. 7a schematically illustrates a stream of data, broadcast or downloaded, comprising blocks Bi in MPEG 4 format.

Initial processing of this stream, carried out at the sender, consists of reorganising the MPEG blocks as a function of the respective processing capacities and speeds of the module M1 and of the SIM card.

FIG. 7b shows the stream of FIG. 7a in which a family formed by blocks of type A and a family formed by blocks of type B were created.

In this example, the blocks of type A will be descrambled by the module M1 and the blocks of type B by the SIM card.

Due to the fact that the capacity and the processing speed of the SIM card are less than those of the decoder, as they are sent the blocks of type B are offset by three blocks upstream so as to compensate for the difference in processing speed between the decoder and the SIM card.

FIG. 7c illustrates the time distribution of the blocks of the stream broadcast after scrambling and reorganisation.

FIG. 7d illustrates the time distribution of the blocks of the stream received by the PDA before descrambling, and FIG. 7e illustrates the time distribution of the blocks of the descrambled stream.

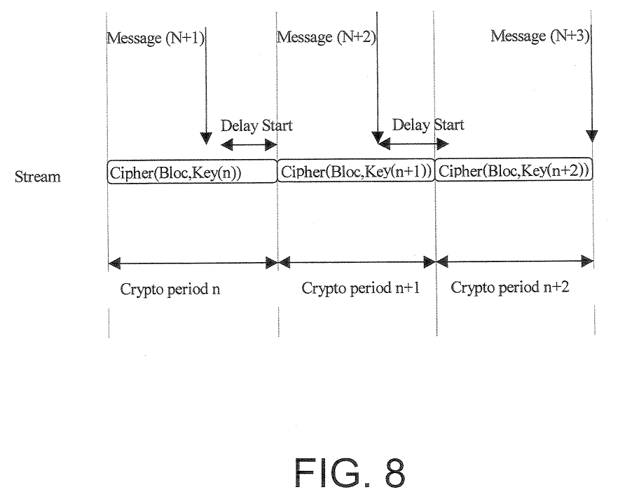

FIG. 8 schematically illustrates the key change mechanism for descrambling the blocks of the processed stream.

The duration of validity of an descrambling key is designated by crypto period. Prior to each start of a crypto period a message is inserted into the stream to warn the descrambling module of the change in crypto period. This message contains all information necessary to descramble the stream during the following crypto period (for example the reference of the descrambling key to be utilised). This message is inserted into the stream before the start of the crypto period (delay start) to enable the descrambling module to process the information of the message and be ready to descramble the data of the coming crypto period in real time.

Applications

This invention applies to the contents whereby the loss of part of the information renders the content unexecutable. This applies to the entire compressed audio and video contents where the loss of information is translated by rapid degradation of the quality (audio, video, ebook, portable ring tones, image).

The deciphering modules are:

portable media of smart card type, contactless smart card, detachable module (PCMCIA, series, USB, Ethernet),

PC type terminals, server, digital decoder, mobile receiver (Mobile Telephone, PDA).

Services

VOD (Video On Demand) by broadcast or by download,

MOD (Music On Demand) by broadcast or by download,

Broadcasting of online electronic book,

Broadcasting of ring tone for mobile telephone,

Broadcasting of photo/image,

Broadcasting of text, multimedia document.

1-19. (canceled)

20. A method for securing scrambled data supplied to a plurality of receiver terminals, each of the terminals including a plurality of descrambling modules, each having a specific processing capacity and a specific level of security, the data being previously subdivided into M families, each comprising N blocks, the method comprising:
at a transmission, each block of a family is scrambled by a key associated with the family, defined as a function of a specific processing capacity and a level of security of the respective deciphering modules; and
at a reception, each block of a family is descrambled by the key associated with the family.

21. The method as claimed in claim 20, wherein the descrambling modules are different peripheral elements associated with the receiver terminal.

22. The method as claimed in claim 21, wherein the descrambling modules comprise different algorithms.

23. The method as claimed in claim 21, wherein the descrambling modules comprise identical algorithms.

24. The method as claimed in claim 20, wherein the data to be distributed are in a form of a previously stored file.

25. The method as claimed in claim 20, wherein the data to be secured are in a form of a broadcast or downloaded stream and processed in real time by the terminal.

26. The method as claimed in claim 25, wherein a duration of use of the stream is divided into crypto periods, each corresponding to a descrambling key, and wherein prior to each start of the crypto period a message is inserted into the stream so as to warn the descrambling module of the change in crypto period.

27. The method as claimed in claim 26, wherein the message comprises all information necessary for descrambling the stream utilized during the following crypto period.

28. The method as claimed in claim 20, wherein the data represent audio and/or video programs protected by a DRM system.

29. The method as claimed in claim 20, wherein the data represent images synthesis or animé drawings.

30. A system for securing scrambled data supplied to at least one receiver terminal, comprising:
a scrambling platform comprising:
means for subdividing the data into M distinct families of N blocks;
means for assigning each family a specific identification parameter associated with at least one descrambling module having a specific processing capacity and a specific level of security; and
means for scrambling each block by a key in biunivocal relation with the parameter; and
a descrambling platform comprising means for identifying the family of each block so as to descramble each block of a family by the descrambling module corresponding to the parameter.

31. The system as claimed in claim 30, wherein the descrambling modules are distinct peripherals associated with the receiver terminal.

32. A scrambling platform for a stream of data, comprising:
means for subdividing the stream into M distinct families of N blocks;
means for assigning each family a specific identification parameter associated with at least one descrambling module having a specific processing capacity and a specific level of security;
means for defining for each module a key as a function of the processing capacity and a degree of security; and
means for scrambling each block belonging to a family by a key in biunivocal relation with the parameter.

33. A descrambling platform for a stream of data scrambled by the platform of claim 32, comprising:
means for identifying the family of each block so as to descramble each block of a family by the descrambling module corresponding to the parameter.

34. The descrambling platform as claimed in claim 33, comprising a plurality of distinct descrambling modules each identified by the specific identification parameter.

35. The descrambling platform as claimed in claim 34, wherein the receiver terminal is a PDA and one of the descrambling modules is integrated into the PDA, and at least a second descrambling module is a smart card of SIM type connected to the PDA.

36. Utilization of the process as claimed in claim 20 for securing a video-on-demand service (VOD).

37. Utilization of the process as claimed in claim 20 for securing a music-on-demand service (MOD).

38. Utilization of the process as claimed in claim 20 for securing access to a broadcast service for electronic books either online or downloaded from portable media.
